(19) United States
(12) Patent Application Publication
(10) Pub. No.: US 2024/0254040 A1
(43) Pub. Date: Aug. 1, 2024

(54) SURFACE-STRUCTURED GLASS ELEMENT AND METHOD FOR PRODUCING IT

(71) Applicant: SCHOTT Technical Glass Solutions GmbH, Jena (DE)

(72) Inventors: Patrick Bartholome, Jena (DE); Hubert Wieseke, Jena (DE); Sandra von Fintel, Jena (DE); Felix Dreisow, Jena (DE)

(73) Assignee: SCHOTT Technical Glass Solutions GmbH, Jena (DE)

(21) Appl. No.: 18/428,107

(22) Filed: Jan. 31, 2024

(30) Foreign Application Priority Data
Jan. 31, 2023 (DE) 10 2023 102 204.0

(51) Int. Cl. C03C 23/00; G06K 19/06

(52) U.S. Cl. CPC C03C 23/0025; G06K 19/06037

(57) ABSTRACT

A glass element includes a glass surface including a surface structuring with a structured region of the glass surface that, owing to glass removal, has a higher roughness than an adjoining unstructured region of the glass surface, the structured region having a mechanical stress profile which can be measured by stress birefringence. The structured region has a compressive stress on the glass surface that is higher in absolute terms than a stress in the adjoining unstructured region. At least one of the following is satisfied: the compressive stress becomes smaller in absolute terms with increasing depth and transitions into a tensile stress, a maximum tensile stress being smaller in absolute terms than the compressive stress on the glass surface; or the compressive stress has a value of less than 5 MPa in absolute terms on the glass surface and becomes smaller in absolute terms with increasing depth.

### CROSS REFERENCE TO RELATED APPLICATIONS

This application claims priority to German Patent Application No. 10 2023 102 204.0 filed on Jan. 31, 2023, which is incorporated in its entirety herein by reference.

### BACKGROUND OF THE INVENTION

### 1. Field of the Invention

The invention generally relates to the structuring of glasses. In particular, the invention relates to surface structurings with a high strength that can be set.

### 2. Description of the Related Art

A known technique for the surface structuring of glasses is laser ablation. Material on the surface of the glass is sublimated at certain points by a pulsed, intensive laser beam. Stringing together such ablation points and/or causing the laser beam to act on a surface point multiple times makes it possible to generate targeted structurings. Among other things, it is thus also possible to provide the surface with an encoding, such as a QR code. This is useful, for example, if the respective glass elements are to be characterized individually. One problem in this respect, however, is that such a marking constitutes damage to the surface, which usually also reduces the strength. In order to reduce this undesired effect, EP 3 815 916 A1 discloses a method in which, to ascertain a stress parameter for the object to be marked, a finite element calculation is performed and the marking is made at a location where the stress parameter is below a certain threshold value.

EP 3 815 916 A1 also discloses that the readability of markings, such as the bits of a QR code, made by laser ablation can be optimized by the depth-to-roughness ratio of the ablated regions. By contrast, a reduction in strength, which may be present, is not taken into consideration.

However, the laser structuring generally introduces stresses into the glass surface. This generates microcracks. Up to now, a thermal or chemical aftertreatment has therefore typically been necessary. This also involves an additional process step, if appropriate deformation of the sheet, and the risk of generating surface defects as a result of the heat treatment. In particular, the effect of microcracks is a considerably reduced strength, this in turn possibly leading to the fracture of the glass substrate, which is relatively expensive, and complex, to produce.

What is needed in the art is a way of keeping a reduction in strength caused by markings made in the glass by a material removal method as low as possible and, in addition to raising a reduced strength of a glass element to an adequate and application-oriented level, is a way to not significantly impair the mechanical readability of the marking, such as a QR code.

### SUMMARY OF THE INVENTION

In some embodiments provided according to this disclosure, a glass element includes a glass surface having a surface structuring, the surface structuring including at least one structured region of the glass surface that, owing to glass removal, has a higher roughness than an adjoining unstructured region of the glass surface, the at least one structured region having a mechanical stress profile which can be measured by stress birefringence. The at least one structured region has a compressive stress on the glass surface that is higher in absolute terms than a stress in the adjoining unstructured region. The at least one structured region also has at least one of the following properties: the compressive stress becomes smaller in absolute terms with increasing depth and transitions into a tensile stress, a maximum tensile stress being smaller in absolute terms than the compressive stress on the glass surface; or the compressive stress has a value of less than 5 MPa in absolute terms on the glass surface and becomes smaller in absolute terms with increasing depth.

In some embodiments provided according to this disclosure, a method for producing a glass element including a glass surface which has a surface structuring with at least one structured region of the glass surface that has a higher roughness than an adjoining unstructured region of the glass surface is provided. The method includes: producing the at least one structured region by directing a pulsed laser beam onto the glass surface, the laser pulses of which remove glass from the glass surface by ablation. Ablation points are made next to one another such that the at least one structured region on the glass surface has a compressive stress that is higher in absolute terms than a stress in an adjoining unstructured region and such that the compressive stress becomes smaller in absolute terms with increasing depth and transitions into a tensile stress. A maximum tensile stress is smaller in absolute terms than the compressive stress on the glass surface.

In some embodiments provided according to this disclosure, a batch includes multiple glass elements. Each of the glass elements includes a glass surface having a surface structuring, the surface structuring including at least one structured region of the glass surface that, owing to glass removal, has a higher roughness than an adjoining unstructured region of the glass surface, the at least one structured region having a mechanical stress profile which can be measured by stress birefringence. The at least one structured region has a compressive stress on the glass surface that is higher in absolute terms than a stress in the adjoining unstructured region. The at least one structured region also has at least one of the following properties: the compressive stress becomes smaller in absolute terms with increasing depth and transitions into a tensile stress, a maximum tensile stress being smaller in absolute terms than the compressive stress on the glass surface; or the compressive stress has a value of less than 5 MPa in absolute terms on the glass surface and becomes smaller in absolute terms with increasing depth. The at least one surface structuring of each of the glass elements is in the form of an individual, different encoding.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a glass element with a laser marking;

FIG. 2 and FIG. 3 each show micrographs of a marking on a glass element;

FIG. 4 shows a test device for measuring the fracture strength of glass elements;

FIG. 5 shows a diagram with measured values for the fracture strength of various glass elements;

FIG. 6 shows measured values for the cell contrast of various laser-worked patterns;

FIG. 7 to FIG. 10 show diagrams of the mechanical stresses in glass elements on the basis of the spacing from the glass surface; and

FIG. 11 shows a glass element with a cut-out test-specimen strip.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

The invention provides a glass element having a surface structuring, which comprises at least one structured region of the glass surface that, owing to glass removal, has a higher roughness than an adjoining unstructured region of the glass surface. The structured region has a mechanical stress profile which can be measured in particular by stress birefringence, the stress profile having the following properties:
the structured region on the glass surface has a compressive stress that is higher in absolute terms than the stress in the adjoining unstructured region,
the compressive stress becomes smaller in absolute terms with increasing depth and transitions into a tensile stress, the maximum tensile stress being smaller in absolute terms than the compressive stress on the glass surface.

The structured region of the glass surface may in particular have an ablatively structured surface, or a structure created by glass removal by laser ablation.

A stress profile having the aforementioned properties has the effect of a considerably improved fracture strength of the glass element in the region of the structured region in comparison with a glass element without such a stress profile or with a different stress profile, although the fracture strength can still be less than on an unstructured region. Surprisingly, this makes it possible to improve the fracture strength, even though stresses are introduced into the glass.

Glasses with particular thermal properties are particularly suitable for introducing a stress profile according to this disclosure. In particular, the transformation temperature in combination with the coefficient of thermal expansion can influence the stress introduced into the element by the ablation. Without being restricted to specific glasses, it is expedient if the mean coefficient of thermal linear expansion (20-300° C.) of the glass of the glass element in the range of 20° ° C. to 300° C. is less than 9·10⁻⁶ K⁻¹, optionally less than 6·10⁻⁶ K⁻¹. A coefficient of thermal linear expansion (20-300° C.) of less than 5·10⁻⁶ K⁻¹ or even less than 4·10⁻⁶ K⁻¹ is exemplary.

Another favorable property of the glass for avoiding the locking-in of high stresses during the laser ablation is a low glass transition temperature. In general, it may be preferred if the glass of the glass element has a glass transition temperature of less than 600° ° C., optionally less than 570° C.

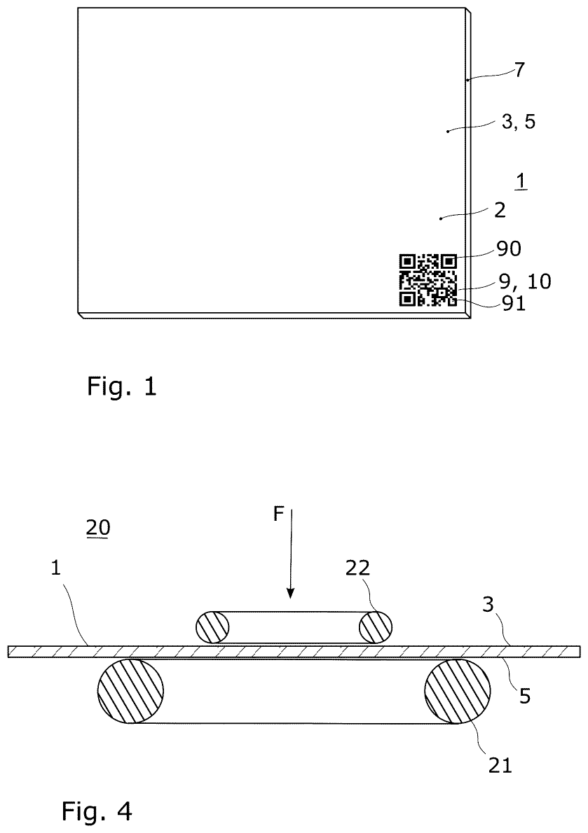

Referring now to the drawings, FIG. 1 shows a perspective illustration of a glass element 1 provided according to this disclosure. As illustrated, the glass element 1 may be sheet-like and in that case accordingly has two opposite side faces 3, 5 and an edge face 7. The outer periphery of the glass element 1 is formed by the edge face 7. A marking 9, which according to some embodiments, like in the illustrated example, has the form of a matrix code 10 is also applied to the surface of the glass element 1. The individual code elements of the matrix code are illustrated as black and white fields. The black fields can represent structured regions 90 and the white fields can represent unstructured regions. Owing to the higher roughness of the structured regions 90 in comparison with the unstructured regions 91, they can be distinguished from one another optically, with the result that an optical detection device can read out the matrix code 10.

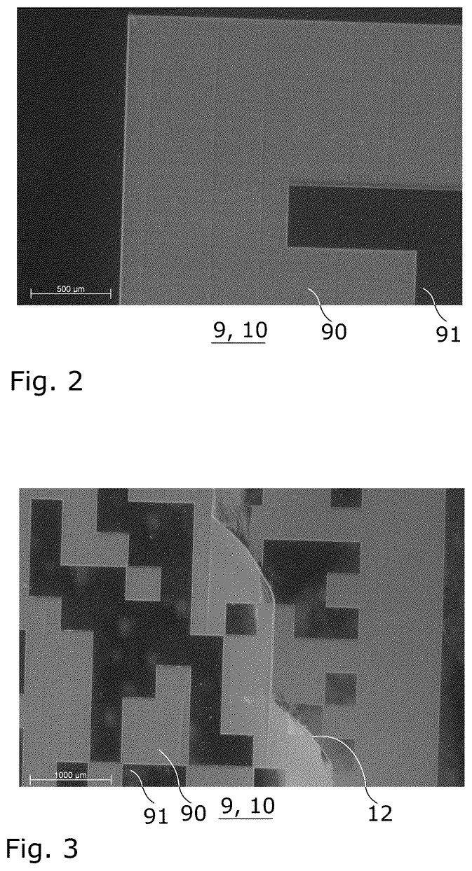

The surface structuring 9 is illustrated in more detail on the basis of FIG. 2 and FIG. 3. The two figures show optical micrographs of details of a surface structuring 9 in the form of a matrix code with different magnifications. The surface structuring 9 was produced by ablation using an ultrashort-pulse laser. As can be seen with reference to the two images, the marking 9 is subdivided into structured regions 90 and unstructured regions 91. The structured regions 90 created by laser ablation appear brighter than the unstructured regions 91 in the images. This is caused by the increased roughness in the structured regions 90 and the associated light scattering. In order to investigate the strength of the glass element 1, the glass element 1 was subjected to a fracture test. A flexural stress was applied to the glass element until it fractured. The resulting crack can be readily seen in the micrograph in FIG. 3.

FIG. 4 shows a test device 20 for measuring the fracture strength of glass elements 1 by a ring-on-ring test. The test device 20 comprises a first ring 21, onto which the glass element 1 to be tested is placed, and a smaller, second ring 22. The second ring 22 is arranged concentrically with the first ring 21 and the two rings are pressed against one another by a force F, symbolized by an arrow, with the result that a flexural stress is exerted on the glass element 1 arranged between the rings 21, 22. The force F is increased until the glass element 1 cracks. The force at which this occurs, or the flexural stress calculated therefrom, is recorded.

It is evident that, according to this disclosure, surface-structured glass elements 1 have a considerably higher strength in the structured regions than glass elements structured conventionally by laser ablation do.

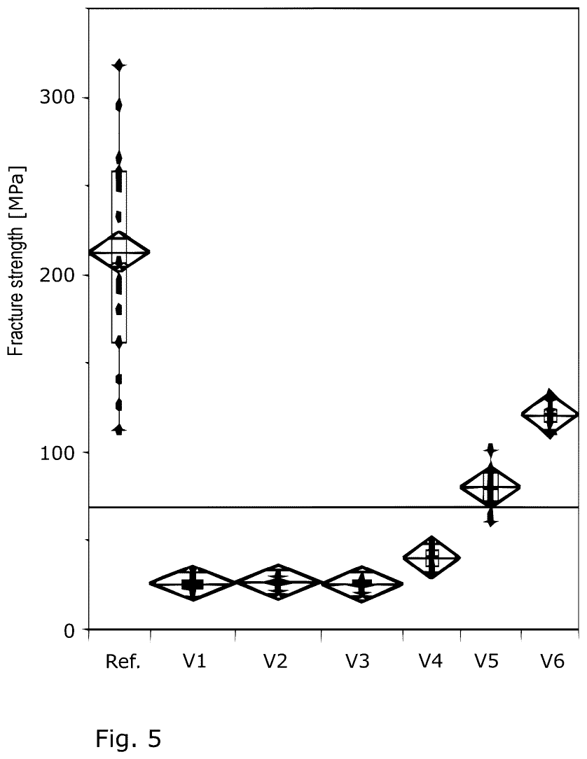

FIG. 5 shows a diagram with measured values for the fracture strength of various plate-like glass elements. The mean values for the fracture strength are illustrated as crossbars in the rhomboids. The measured values denoted “Ref.” were measured on test specimens without structuring. The test specimens “V1”, “V2” and “V3” are test specimens that were structured conventionally by laser ablation. The measured values “V4”, “V5” and “V6” were measured on test specimens that have the stress profile according to this disclosure in the structured regions, in the case of which therefore the structured regions of the matrix code on the glass surface 2 have a compressive stress which is higher in absolute terms than the stress in adjoining unstructured regions 91, wherein the compressive stress decreases with increasing depth and transitions into a tensile stress, wherein the maximum tensile stress is smaller in absolute terms than the compressive stress on the glass surface 2. For the measurements, use was made of test specimens made of borosilicate glass, specifically made of a glass referred to below as “Glass 1”, which can be obtained under the trade name BOROFLOAT® 33 and has a coefficient of thermal expansion of 3.25·10⁻⁶ K⁻¹. This glass is an example of a class of borosilicate glasses with coefficients of thermal expansion of less than 3.9·106 K⁻¹ according to one embodiment of worked glass elements, or suitable glasses provided according to this disclosure. Without being restricted to the examples discussed here, glass elements made of borosilicate glass may be preferred, since these glasses can be used to set the desired stress profiles easily by virtue of suitable method parameters for the laser ablation. The series of test specimens “V4” to “V6” each differ in terms of the parameters for the laser ablation.

As can be seen from this diagram, the fracture strength of the test specimens structured in the conventional way is considerably reduced with respect to an untreated glass plate. Specifically, it is evident that the strength of the conventionally structured test specimens is reduced by approximately 80% with respect to the unstructured reference test specimen. In this context, a conventionally structured test specimen is understood to mean a test specimen in the case of which the laser beam scans the regions for structuring one after another in paths that lie directly next to one another. It can also be seen that, on the other hand, a considerable increase in strength can be observed for all the test specimens structured according to this disclosure. In the case of the test specimen denoted “V6”, the strength in the structured region 90 is already comparable with the strength of an unstructured test specimen and stronger than the conventionally structured test specimens of the series “V1, “V2” and “V3” by a factor of 5.

The statistical values for the fracture strength in MPa for the examples “Ref.”, “V1”, “V4”, “V5” and “V6” are reported in the following Table 1.

TABLE 1

| Series | Ref. | V1 | V4 | V5 | V6 |
|---|---|---|---|---|---|
| Min | 112.1 | 21.1 | 32.1 | 61.3 | 109.9 |
| Q25 | 170.7 | 24.4 | 35.8 | 73.0 | 117.3 |
| MV | 212.3 | 25.6 | 40.1 | 79.9 | 121.0 |
| Median | 206.8 | 25.6 | 40.7 | 79.7 | 121.3 |
| Q75 | 256.0 | 26.4 | 44.4 | 88.8 | 123.2 |
| Max | 317.5 | 32.0 | 47.9 | 101.2 | 132.0 |

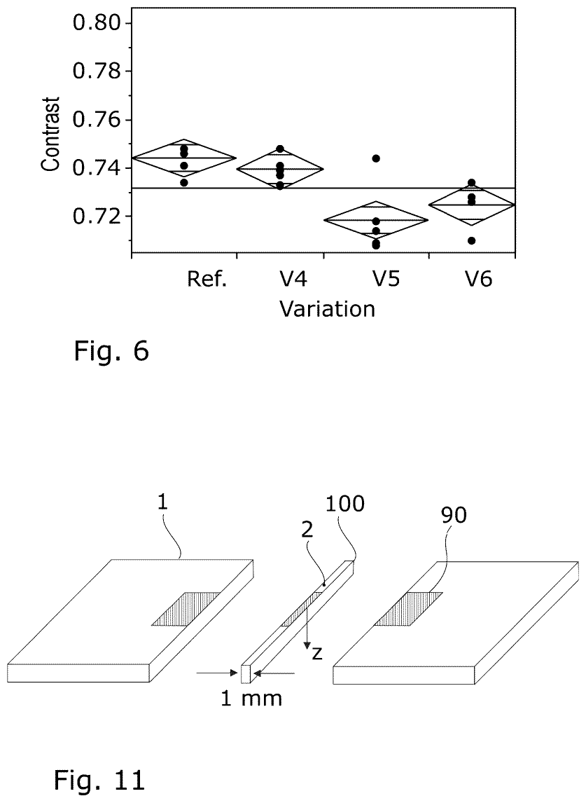

FIG. 6 illustrates single-factor analyses of the cell contrast of matrix codes. The analyses were carried out for four different patterns. The test specimen denoted “Ref.” is a conventionally structured test specimen corresponding to the test specimens “V1”, “V2” and “V3” from FIG. 5. As can be seen from FIG. 6, the contrast corresponding to the parameter “Cell contrast” is comparable to AIM DPM-1-2006 for the test specimens structured according to this disclosure and above a value of 0.7. The contrast can be recorded in accordance with ISO I/IEC TR 29158 or AIM DPM-1-2006 by micrographs under diffuse lighting, for example by 90° dome lighting or by light sources which are radiated in onto the glass element from four directions, each with an angle of incidence of 45°. As can be seen, the cell contrast in all the examples is at least 0.72. Without being restricted to the specific examples, in this respect one embodiment provides that the at least one structured region 90 is a constituent part of an optically detectable marking 9, in particular a matrix code 10, wherein the marking 9 has a cell contrast of at least 0.7.

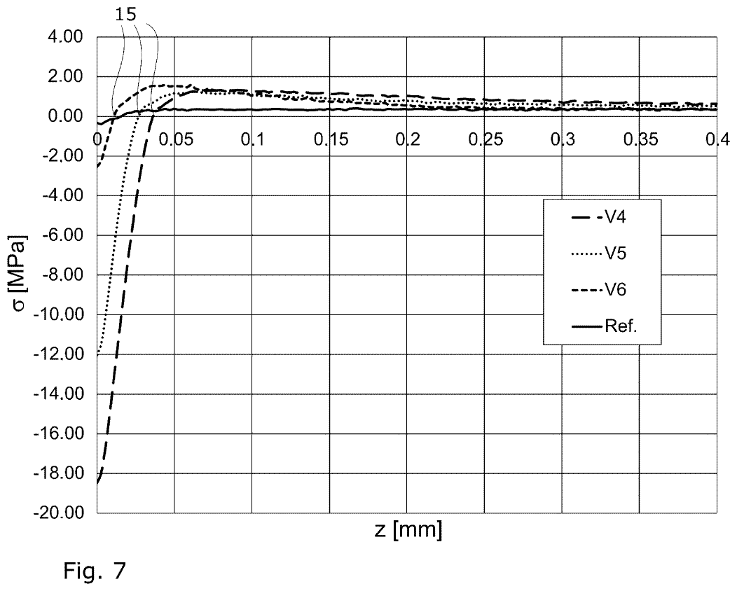

FIG. 7 shows diagrams of the mechanical stresses in the glass element 1 on the basis of the depth, or the spacing z from the glass surface. The measurements were carried out at the three test specimens structured according to the invention, “V4”, “V5” and “V6”, for which the mean fracture strengths and the cell contrast are also shown in FIG. 5 and FIG. 6. The stress profile of an unstructured reference test specimen denoted “Ref.” is shown as a comparison. For the measurements, as shown in FIG. 11, a 1 mm wide test-specimen strip (length approximately 25 mm) was taken from the glass elements which extends through the middle of the QR matrix code, or a structured region 90. The cut surfaces were polished and the stress birefringence down to a spacing of 1.4 mm from the glass surface 2 in the z direction, perpendicular to the cut surfaces, was measured. The measuring appliance used for the measurement was a Hinds Instruments Exicor Microimager.

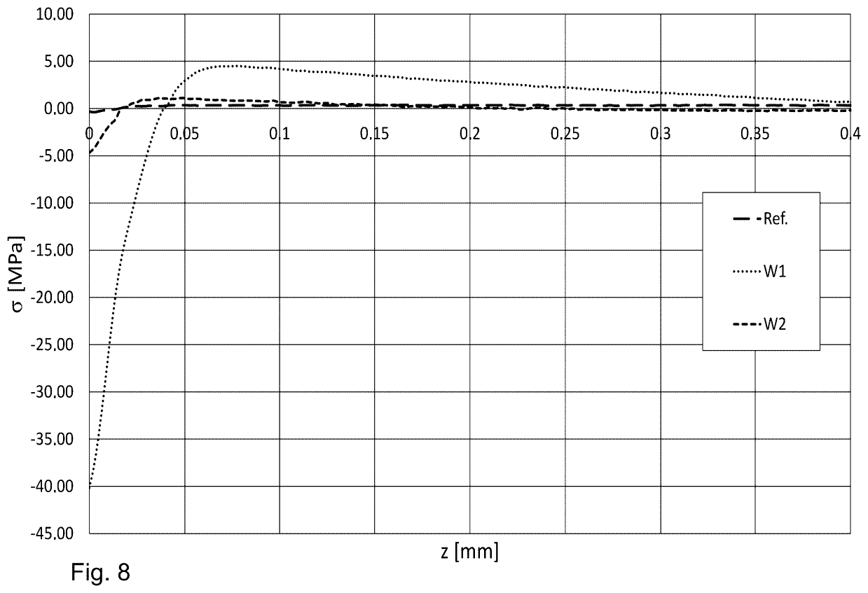

The measured values d of the stress birefringence were converted into stresses by the relationship d=1 mm/SOC. For Glass 1, a value of 4.01·1/Tpa was taken as a basis for the stress optical coefficient SOC of the glasses investigated. For the exemplary embodiments described below on the basis of FIG. 8 to FIG. 10 of the glasses “Glass 2”, “Glass 3” and “Glass 4”, use was also made of the following stress optical coefficients: for Glass 2 a value of 3.60.1/TPa, for Glass 3 a value of 3·10.1/TPa and for Glass 4 a value of 2.79.1/TPa. Measurements were taken at four respective randomly selected positions. In addition, for each test-specimen strip 100, one position outside the structured region 90 was measured. In the measurement results, the glass starts at z=0. The QR matrix code, or the structured region is at z<0, since material on the surface was removed by the ablation.

Tensile stresses are always positive in the measurement results of FIG. 7; compressive stresses are depicted as negative. The reference test specimen has no significant stresses on the surface and in the regions close to the surface. For the test specimens structured according to this disclosure, by contrast, a characteristic stress profile is obtained, in the case of which a compressive stress which decreases and, at a greater depth, transitions into a tensile stress is present on the glass surface 2. In all cases, the tensile stress is smaller in absolute terms than the maximum compressive stress on the glass surface.

As can be seen from the diagram, it is good for the strength if the transition point 15 between compressive and tensile stress is as close to the glass surface 2 as possible. Another criterion is a low maximum compressive stress on the glass surface 2. Thus, the fracture strength increases from test specimen “V4” through test specimen “V5” to test specimen “V6”, wherein at the same time the transition point gets closer to the glass surface and the maximum compressive stress decreases. Without being restricted to the examples illustrated, it is therefore expedient if, in the structured region 90, the product of the depth z of the transition point at which the compressive stress transitions into a tensile stress and the maximum compressive stress, that is typically the compressive stress on the glass surface, has an absolute value of less than 0.05 mm×45 MPa, optionally less than 0.05 mm×20 MPa, that is less than 2.25 MPa·mm, optionally less than 1 MPa·mm. It may be preferable if the product has a value of at most 0.1 MPa·mm. In the case of the test specimen “V6” with the highest strength, the product of the depth z of the transition point 15 and the maximum compressive stress has a value of only 0.025 MPa·mm. The parameters of the depth of the transition point and the maximum absolute compressive strength are also essential for the fracture strength of the glass element 1 on a structured region taken by themselves. Thus, according to an alternative or additional embodiment, it is provided that the transition point 15 between compressive and tensile stress in the structured region 90 is at a depth of at most 0.05 mm. Lastly, it is expedient if the maximum compressive stress in the structured region 90, in particular the compressive stress on the glass surface 2, is at most 20 MPa in absolute terms.

This stress profile and the strength of a glass element 1 obtained thereby in the region of a marking is also therefore especially advantageous because it is possible to dispense with annealing, that is to say relieving the tension by a subsequent temperature treatment, for example to a temperature just below T_{g}. There is also lower warp in the case of flat glass elements 1.

The method parameters used to produce structured glass elements 1 according to the examples “V1” to “V6” described above will be described below. The test specimens used for the examples “V1” to “V6” are each glass elements 1 made of borosilicate glass of the BOROFLOAT® 33 type. Moreover, test specimens of glasses denoted “Glass 2”, “Glass 3” and “Glass 4” having the stress optical coefficients specified above were investigated. The test specimens “W1” and “W2” were glass elements made of Glass 2, the test specimens “W3” and “W4” were made of Glass 3 and the test specimens “W5” and “W6” were made of Glass 4. Glass 2 is an example of one embodiment in the form of a borosilicate glass having a coefficient of thermal linear expansion α(20-300° C.) in the range of 3.9·10⁻⁶K⁻¹ to 6·10⁻⁶K⁻¹. Glass 3 is a glass from a class of borosilicate glasses having a coefficient of thermal linear expansion α(20-300° C.) in the range of 6·10⁻⁶K⁻¹ to 9·106K⁻¹, according to another embodiment of suitable glasses. Lastly, Glass 4 is a glass from the group of lithium-aluminosilicate glasses (LAS glass), in particular an example of a lithium-alumino-borosilicate glass (LABS glass) as a subclass of LAS glasses. These glasses are distinguished by high strengths, among other things. In addition to borosilicate glasses, lithium-aluminosilicate glasses and in particular lithium-alumino-borosilicate glasses may also be preferred glasses for working by the method provided according to this disclosure. Some properties of the glasses, Glass 1 to Glass 4, are reported below in Table 3. The glass elements 1 have a dimension of 100×100 mm and a glass thickness of 1.8 mm. A matrix code 10, specifically a data matrix code with a dimension of 10×10 mm, was made centred in the middle of the glass elements by a laser. In some embodiments and generally, without being restricted to specific examples, the laser source generates laser pulses with a wavelength of at least 900 nm, optionally in the range of 900 nm to 3 μm, optionally in the range of 1000-1100 nm. In the examples described below, a laser with a wavelength of 1030 nm was used. The pulse duration was generally optionally less than 1 nanosecond. It is optionally in the range of 100 fs to 10 ps, specifically is approximately 1 ps. A spot diameter of the laser beam on the glass surface of approximately d=15 μm was obtained, wherein the pulse energy can correspond to at most three times the ablation threshold, typically 2 times.

The laser parameters are set out in more detail in the following Table 2.

TABLE 2

| | | k1 pulse | | | Line | Pulse | |
|---|---|---|---|---|---|---|---|
| Test | f | duration/traversal | Temporal | Traversals | spacing | density | |
| specimen | [kHz] | [μm⁻¹] | pulse split | (N) | [μm] | (k) [μm⁻¹] | DMC content |
| V1 | 1000 | 10 | 1 | 1 | 1.3*d | 10 | GS3H1111 |
| V2 | 1000 | 10 | 1 | 1 | d | 10 | GS3H1111 |
| V3 | 1000 | 10 | 1 | 1 | 0.5*d | 10 | GS3H1111 |
| V4 | 1000 | 5 | 2 | 1 | 0.7*d | 5 | GS3H1121 |
| V5 | 1000 | 2.5 | 4 | 2 | 0.7*d | 5 | GS3H1142 |
| V6 | 1000 | 1.25 | 8 | 4 | 0.7*d | 5 | GS3H1184 |
| W1 | 1000 | 10 | 1 | 1 | 0.7*d | 10 | GS3H1111 |
| W2 | 1000 | 1.25 | 8 | 4 | 0.7*d | 5 | GS3H1184 |
| W3 | 1000 | 10 | 1 | 1 | 0.7*d | 10 | GS3H1111 |
| W4 | 1000 | 1.25 | 8 | 4 | 0.7*d | 5 | GS3H1184 |
| W5 | 1000 | 10 | 1 | 1 | 0.7*d | 10 | GS3H1111 |
| W6 | 1000 | 2.5 | 4 | 4 | 0.7*d | 10 | GS3H1144 |

The temporal pulse split specifies how many of the pulses provided by the pulse frequency f are actually discharged. In the case of the test specimens “V4”, “V5” and “V6”, which were structured according to the method described here, a pulse split of at least two is provided, with the result that a lower pulse density, or a lower density of ablation pulses, is present along a traversed line. The pulse density per traversal is described by k1 and specifies the number of pulses per micrometre of path length. The overall pulse density k results from N*k1, where N is the number of traversals.

Various properties of the glasses investigated are set out in the below Table 3.

TABLE 3

| Glass | | Glass 1 | Glass 2 | Glass 3 | Glass 4 |
|---|---|---|---|---|---|
| CTE | ppm/K | 3.25 | 4.15 | 7.20 | 5.31 |
| T_{g} | ° C. | 530 | 589 | 557 | 577 |
| Modulus of | GPa | 63 | 69 | 73 | 81 |
| elasticity | | | | | |
| μ | | 0.2 | 0.194 | 0.21 | 0.26 |
| Thermal | W/K/m | 1.2 | 1.2 | | |
| conductivity | (100° C.) | | | | |

In general, without being restricted to the examples set out in the above Tables 2 and 3, in this respect provision is made of a method for producing a glass element 1 having a surface structuring 9, which comprises with at least one structured region 90 of the glass surface 2 that has a higher roughness than an adjoining unstructured region 91 of the glass surface 2, wherein the at least one structured region 90 is produced by directing a pulsed laser beam onto the glass surface 2, the laser pulses of which remove glass from the glass surface 2 by ablation, and wherein the ablation points are made next to one another such that
the structured region 90 on the glass surface 2 has a compressive stress that is higher in absolute terms than the stress in an adjoining unstructured region 91, and such that
the compressive stress becomes smaller in absolute terms with increasing depth and transitions into a tensile stress, wherein the maximum tensile stress is smaller in absolute terms than the compressive stress on the glass surface 2.

In particular, the laser beam traverses the area with the structured region 90 for production multiple times, in paths that lie next to one another, in order to remove glass along these paths by ablation, wherein the pulse frequency of the laser beam and the speed at which the laser beam is guided over the glass surface 2 are set such that, along a path, the area is worked with a pulse density of k1≤5 pulses per micrometre, optionally k1≤2.5 pulses per micrometre of path length, or such that the pulse density while the area is being traversed is at most 5, optionally at most 2.5 pulses per micrometer. A pulse density is particularly optionally at most 1.25 per micrometer. The overall pulse density may, however, be considerably higher if approximately the area as in examples V5 and V6 is traversed, or scanned, multiple times. Traversal multiple times is understood to mean a scanning of the area which is repeated at least once. In the case of the examples “V4”, “V5” and “V6” specified in the table, only five laser pulses were discharged at a location in each case. In comparison with the comparative examples “V1” and “V2”, the spacing between paths that lie next to one another is 0.7*d less for this. Without being restricted to the examples illustrated, in this respect, one refinement of the method provides that the area with the structured region for production is traversed by the laser beam in paths that lie next to one another, so that the paths are at a spacing of at most or less than d. As an alternative or in addition, it may be provided that the spacing is at most 12 μm. Accordingly, one refinement of the method provides two embodiments according to which:
the area with the structured region 90 for production is traversed, in paths that lie next to one another, by the laser beam such that the paths are at a spacing of at most 12 micrometres, and/or wherein
the area with the structured region 90 for production is traversed, in paths that lie next to one another, by the laser beam such that the paths are at a spacing which is at most the diameter of the laser beam on the glass surface. Also important for the stress profile inside the structured region 90 is the interval between successive laser pulses which generate ablation points next to one another along a path.

According to one embodiment of the method, the interval between successive laser points is at least 1.5 microseconds. A comparison of the method parameters according to the table with the strengths according to FIG. 5 also makes it clear that particularly high strengths can be achieved by keeping k1 low.

For a consistent contrast of the matrix code, the structured region 90 for production can be traversed by the laser beam multiple times, that is at least twice, in paths that lie one above another, with the result that the overall pulse density k “is consistent”, or is as high as possible. The paths of the traversals may also be transverse to one another, in particular perpendicular to one another. Thus, it is possible for a first traversal of the area with the region 90 for structuring to be traversed with a set of parallel paths and a further traversal to be traversed with another set of paths that are parallel but are transverse, in particular perpendicular, to the paths of the first traversal.

FIG. 8 to FIG. 10 show, analogously to FIG. 7, the profile of the stresses on glass elements 1 on the basis of measurements of the stress birefringence for other glass types. The curve denoted “Ref.” in each case is the curve, shown already in FIG. 7, of the stress on a reference test specimen made of the borosilicate glass Glass 1. FIG. 8 shows the profiles of the test specimens W1 and W2 made of the borosilicate glass Glass 2 according to the above table. The test specimen W2 exhibits considerably lower stresses on the structured glass surface than the sample W1. As is also the case for Glass 1, this reduction is obtained by the lower pulse density per traversal, this being achieved for test specimen W2 by a temporal pulse split of 8, or an eight-fold reduction in pulse frequency, and a pulse density reduced by a factor of 2 (see Table 2).

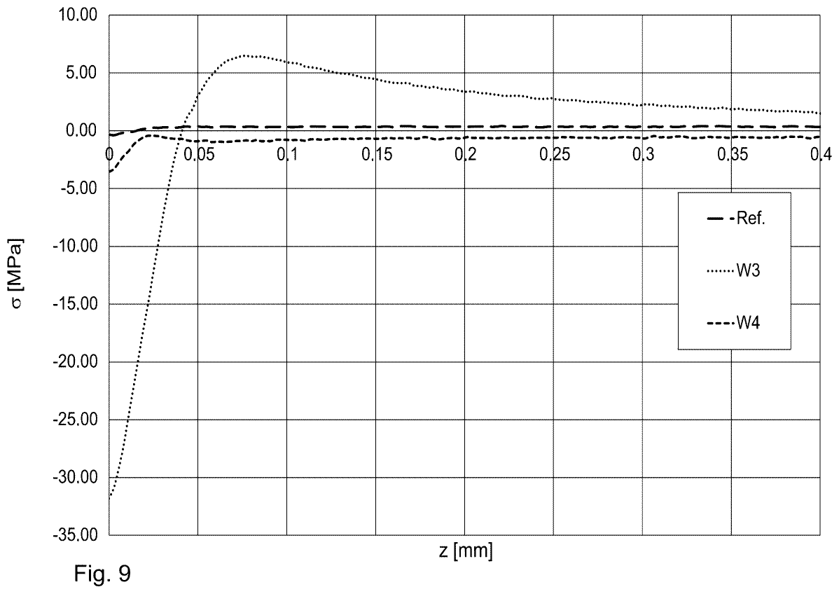

FIG. 9 shows corresponding measured values for Glass 3, likewise made of borosilicate glass, but with a higher coefficient of thermal expansion. The test specimen W4 was worked, analogously to the test specimen W2, with a pulse frequency reduced by a factor of 8 compared to test specimen W3 and a pulse density reduced by a factor of two. As is also the case for the other glasses, the low pulse density of less than eight laser pulses per micrometre of path length has the effect of considerably lower stresses in absolute terms on the structured glass surface that continue to decrease in absolute terms as the depth increases. By contrast to the other examples, the compressive stress, however, does not transition into a tensile stress but approaches the zero line, or a stressless state. The stress even exhibits an intermediate minimum at a depth of approximately 0.02 millimeters.

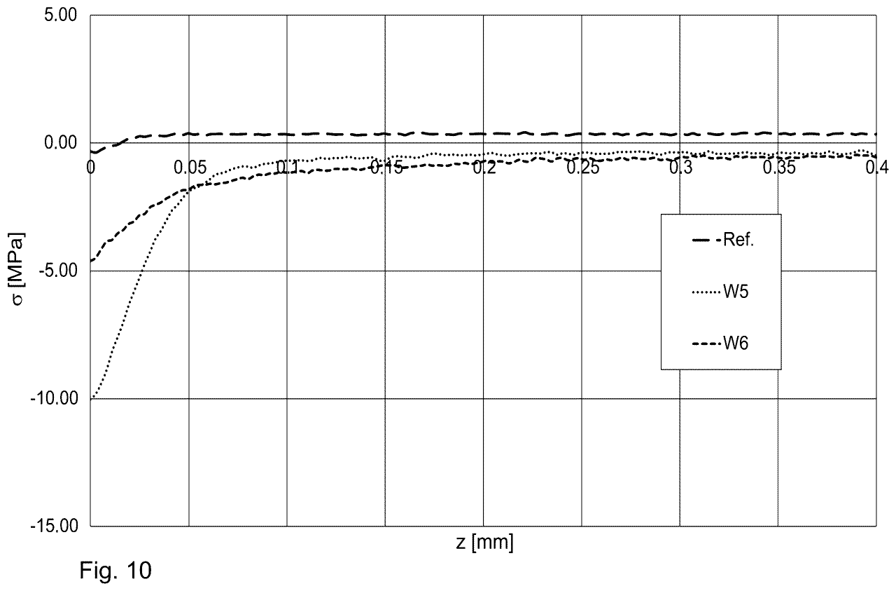

Corresponding measurements on test specimens of glass elements 1 of the glass type Glass 4, a lithium-alumino-borosilicate glass, are shown in FIG. 10. By contrast to the examples of FIG. 8 and FIG. 9, in the case of the test specimen W6 the pulse frequency was reduced only by a factor of 4 compared to the test specimen W5, and the number of traversals was increased from 1 to 4. The spatial pulse density, or the number of pulses per μm, thus remains the same compared to the test specimen W5. A larger local spacing between temporally successive ablations on the surface is also produced here owing to the lower pulse frequency and multiple traversals. It is also the case for this further glass type that the reduction in the pulse frequency for the test specimen W6 compared to test specimen W5 means that it exhibits a lower stress in absolute terms, in particular a lower compressive stress in absolute terms, on the glass surface in the worked region. However, in a similar way to the example of FIG. 9, the compressive stress does not transition into a tensile stress with increasing depth, but gets closer to a stress-free state. In the example of FIG. 10, this also applies to the test specimen W5 worked with a higher pulse density.

This is because glass elements treated according to the method described here of the test specimens W2, W4 and W6, and also V6, in which the ablation was performed with less than eight pulses per micrometer of path length, share the feature that the compressive stress on the glass surface worked by ablation is less than −5 MPa, with the compressive stress decreasing with increasing depth in the glass, irrespective of because it transitions into a tensile stress or because it gets closer to a stressless state in absolute terms. According to an alternative or additional embodiment, therefore, in general provision is made of a glass element 1 with a surface structuring 9 which comprises at least one structured region 90 of the glass surface 2 that has a higher roughness than an adjoining unstructured region 91 of the glass surface 2 owing to glass removal, and wherein the structured region 90, or its stress profile, moreover has at least one of the following properties:
the structured region 90 on the glass surface 2 has a compressive stress that is higher in absolute terms than the stress in the adjoining unstructured region 91,
the compressive stress has a value of less than 5 MPa in absolute terms on the surface and becomes smaller in absolute terms with increasing depth.

The glass elements worked by the method described here, as can be seen from FIG. 7 to FIG. 10, also share the feature that the surface compressive stress decreases within a small depth. In general, in this respect, one embodiment of the invention that is not restricted to specific examples provides that the compressive stress decreases from the value on the glass surface 2 to a compressive stress of less than 3 MPa in absolute terms within a depth of less than 0.03 mm.

It is clear from the last column in Table 2 that various matrix codes were introduced into the glass. The laser ablation affords the considerable advantage here of being able to perform a straightforward, individual characterization. Therefore, one refinement of the method provides that a batch of multiple glass elements is provided, wherein the glass elements are provided with surface structurings 9, optionally in the form of matrix codes 10, wherein the surface structurings differ from one another, so that the glass elements 1 can be distinguished from one another and identified by the surface structurings. Since a subsequent cooling process can be omitted, there is also the option here of marking temperature-sensitive products. What is conceivable here, among other things, is the characterization of glass elements 1 in the form of filled glass containers. For example, pharmaceutical containers filled with pharmaceutical products can be individually characterized.

The glass elements 1 described here and their methods of production can be used generally to individually characterize glass products. In particular, in addition to glass containers, glass wafers and optical elements, such as lenses or prisms, can be marked. Accordingly, one embodiment provides a batch having multiple glass elements, in particular in the form of glass containers, glass wafers or optical elements, which have surface structurings 9 in the form of individual, different encodings. A further application is microfluidic devices, such as microfluidic chips. Such devices generally have a three-dimensional structuring for taking up liquid and conducting liquid. Such devices, like other glass elements, can also have multiple layers. A further intended application is for general composite glass elements with at least two bonded glass parts. The composite glass element may in particular also be structured like in the application as microfluidic device. Yet another application is for glass elements which serve as housing element, optionally for optoelectronic components. For example, it is conceivable to individually characterize glass wafers bonded to semiconductor wafers in order to pack components on the wafer plane.

As can be seen from the table with the laser parameters, the fracture strength can not only be increased but also selectively set in the region of a marking. To this end, it is also conceivable to add an intended fracture point to a surface structuring. In general, therefore, a further aspect of this disclosure provides a glass element 1 which has a surface structuring 9, which comprises at least one structured region 90 of the glass surface 2 that has a higher roughness than an adjoining unstructured region 91 of the glass surface 2 owing to glass removal, and wherein the structured region 90 has a mechanical stress profile which can be measured in particular by stress birefringence, in which the structured region on the glass surface has a compressive stress that is higher in absolute terms than the stress in the adjoining unstructured region 91, wherein the difference between the stresses reduces the strength of the glass element on the structured region to a great enough extent that the surface structuring 9 forms an intended fracture point. The feature that the compressive stress becomes smaller in absolute terms with increasing depth and transitions into a tensile stress, wherein the maximum tensile stress is smaller in absolute terms than the compressive stress on the glass surface 2, can be satisfied for such an intended fracture point.

It is also possible to combine a surface structuring having increased fracture strength in one glass element with another surface structuring acting in particular as intended fracture point. For example, a glass wafer subdivided into individual separable dies, or parts or small plates, by intended fracture points would be conceivable. The wafer can then have a characterizing surface structuring with increased strength in the form of a code, in particular a matrix code, produced by laser ablation. Similarly, the parts or small plates may also have corresponding encodings. Accordingly, another embodiment provides that the glass element 1, in particular in addition to the surface structuring 9, has an ablatively structured surface structuring which forms an intended fracture point. To this end, the further surface structuring may have a lower fracture strength than the surface structuring 9.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE SIGNS

1 Glass element
2 Glass surface
3, 5 Side faces of 1
7 Edge face of 1
9 Surface structuring
10 Matrix code
12 Crack
15 Transition point between compressive and tensile stress
20 Ring-on-ring test device
21 First ring
22 Second ring
90 Structured region
91 Unstructured region
100 Test-specimen strips

What is claimed is:

1. A glass element, comprising:
a glass surface comprising a surface structuring, the surface structuring comprising at least one structured region of the glass surface that, owing to glass removal, has a higher roughness than an adjoining unstructured region of the glass surface, the at least one structured region having a mechanical stress profile which can be measured by stress birefringence, wherein the at least one structured region has a compressive stress on the glass surface that is higher in absolute terms than a stress in the adjoining unstructured region, wherein the at least one structured region also has at least one of the following properties:
the compressive stress becomes smaller in absolute terms with increasing depth and transitions into a tensile stress, wherein a maximum tensile stress is smaller in absolute terms than the compressive stress on the glass surface; or
the compressive stress has a value of less than 5 MPa in absolute terms on the glass surface and becomes smaller in absolute terms with increasing depth.

2. The glass element of claim 1, wherein at least one of the following is satisfied:
a product of the maximum compressive stress and a depth of a transition point at which the compressive stress transitions into a tensile stress in the at least one structured region has an absolute value of less than 1 MPa*mm;
the transition point between compressive and tensile stress in the at least one structured region is at a depth of at most 0.05 mm;
the maximum compressive stress in the at least one structured region is at most 20 MPa in absolute terms; or
the compressive stress decreases from a value on the glass surface to a compressive stress of less than 3 MPa in absolute terms within a depth of less than 0.03 mm.

3. The glass element of claim 1, wherein the at least one structured region of the glass surface has an ablatively structured surface.

4. The glass element of claim 1, wherein the at least one structured region is a constituent part of an optically detectable marking.

5. The glass element of claim 4, wherein the optically detectable marking is a matrix code.

6. The glass element of claim 4, wherein the optically detectable marking has a cell contrast in accordance with ISO V/IEC TR 29158 of at least 0.7.

7. The glass element of claim 1, wherein the glass element is made from borosilicate glass or lithium-aluminosilicate glass.

8. The glass element of claim 1, wherein a glass of the glass element has at least one of the following features:
a mean coefficient of thermal linear expansion @(20-300)° ° C. of the glass in a range of 20° ° C. to 300° C. is less than 9·10⁻⁶ K⁻¹; or
the glass has a glass transition temperature of less than 600° C.

9. The glass element of claim 1, further comprising an ablatively structured surface structuring, wherein the ablatively structured surface structuring forms an intended fracturing point.

10. A method for producing a glass element comprising a glass surface which has a surface structuring with at least one structured region of the glass surface that has a higher roughness than an adjoining unstructured region of the glass surface, the method comprising:
producing the at least one structured region by directing a pulsed laser beam onto the glass surface, the laser pulses of which remove glass from the glass surface by ablation, wherein ablation points are made next to one another such that the at least one structured region on the glass surface has a compressive stress that is higher in absolute terms than a stress in an adjoining unstructured region and such that the compressive stress becomes smaller in absolute terms with increasing depth and transitions into a tensile stress, wherein a maximum tensile stress is smaller in absolute terms than the compressive stress on the glass surface.

11. The method of claim 10, wherein at least one of the following is satisfied:
the pulses of the laser beam directed onto the glass surface have a pulse duration in a range of 100 fs to 10 ps; or
the pulses of the laser beam directed onto the glass surface have a wavelength of at least 900 nm.

12. The method of claim 11, wherein the wavelength of the pulses of the laser beam is in a range of 900 nm to 3 μm.

13. The method of claim 10, wherein the laser beam traverses an area with the at least one structured region for production multiple times, in paths that lie next to one another, in order to remove glass along these paths by ablation, wherein a pulse frequency of the laser beam and a speed at which the laser beam is guided over the glass surface are set such that a pulse duration along a path while the area is being traversed is at most 5 pulses per micrometer.

14. The method of claim 10, wherein at least one of the following is satisfied:
an area with the at least one structured region for production is traversed, in paths that lie next to one another, by the laser beam such that the paths are at a spacing of at most 12 micrometers;
the area with the at least one structured region for production is traversed, in paths that lie next to one another, by the laser beam such that the paths are at a spacing which is at most a diameter of the laser beam on the glass surface;
an interval between laser points following one another is at least 1.5 microseconds; or
the area with the at least one structured region for production is traversed by the laser beam multiple times in paths that lie next to one another.

15. The method of claim 10, wherein the method provides a batch of multiple glass elements in the form of pre-filled glass containers each having a respective at least one surface structuring, the at least one surface structure of each respective pre-filled glass container differing from the at least one surface structure of other pre-filled glass containers so that the glass elements can be distinguished from one another and identified by the respective at least one surface structuring.

16. A batch, comprising:
multiple glass elements, each of the glass elements comprising:
a glass surface comprising a surface structuring, the surface structuring comprising at least one structured region of the glass surface that, owing to glass removal, has a higher roughness than an adjoining unstructured region of the glass surface, the at least one structured region having a mechanical stress profile which can be measured by stress birefringence, wherein the at least one structured region has a compressive stress on the glass surface that is higher in absolute terms than a stress in the adjoining unstructured region, wherein the at least one structured region also has at least one of the following properties:
the compressive stress becomes smaller in absolute terms with increasing depth and transitions into a tensile stress, wherein a maximum tensile stress is smaller in absolute terms than the compressive stress on the glass surface; or
the compressive stress has a value of less than 5 MPa in absolute terms on the glass surface and becomes smaller in absolute terms with increasing depth;
wherein the at least one surface structuring of each of the glass elements is in the form of an individual, different encoding.

17. The batch of claim 16, wherein the glass elements are in the form of glass containers, glass wafers, microfluidic devices, composite glass elements, housing elements, or optical elements
